(19) United States
(12) Patent Application Publication
(10) Pub. No.: US 2014/0219256 A1
(43) Pub. Date: Aug. 7, 2014

(54) Method of accessing a communication medium used by a plurality of communication terminals

(71) Applicants: Pascal Viger, Janze (FR); Patrice Nezou, Saint-Sulpice La Foret (FR); Julien Sevvin, Saint Aubin Du Cormier (FR)

(72) Inventors: Pascal Viger, Janze (FR); Patrice Nezou, Saint-Sulpice La Foret (FR); Julien Sevvin, Saint Aubin Du Cormier (FR)

(73) Assignee: CANON KABUSHIKI KAISHA, Tokyo (JP)

(21) Appl. No.: 14/127,920

(22) PCT Filed: Jun. 20, 2012
(86) PCT No.: PCT/EP2012/061864

§ 371 Date: Apr. 4, 2014

(30) Foreign Application Priority Data
Jun. 22, 2011 (GB) 1110552.5

(51) Int. Cl. H04W 28/26

(52) U.S. Cl. CPC H04W 28/26
USPC 370/336

(57) ABSTRACT

A method of accessing a communication medium used by a plurality of communication terminals, comprising the following steps, performed by a first communication terminal belonging to a group of communication terminals from the plurality of communication terminals:
detecting 410 an upcoming reservation, by a second communication terminal of the group, of an occupancy time interval of the communication medium,
determining 420 a timeslot in the occupancy time interval, and
transmitting 460 data over the communication medium during the determined timeslot.

The method provides improvements in the communications of communication terminals sharing a communication medium.

The present invention relates a method of sharing an access to a communication medium between terminals.

The 802.11 MAC (acronym of Medium Access Control) standard supports accesses to a shared wireless medium through a technique called Carrier Sense Multiple Access with Collision Avoidance (CSMA/CA). The 802.11 standard is mainly directed to the management of nodes waiting for the medium to become idle so as to authorize access to the medium.

According to a communication mode of that standard, known as Distributed Coordination Function (DCF), a wireless channel, generically referred to as the medium, is sensed by a source node so that transmission of data packets from the source node to a destination node is permitted when the sensed wireless channel is idle. If the channel is sensed as being busy, the source node defers its transmission.

The backoff algorithm is a well-known method to solve contention between different source nodes that need to access a medium (typically a wireless channel) simultaneously: the method requires each of these nodes to choose a random number of time slots, called backoff value or backoff period, and wait for that number of time slots to elapse before accessing the medium again, always checking for each time slot whether or not another node accessed the medium before accessing.

Therefore, when the medium becomes idle, the source node waits for a random backoff period to elapse during which it continues to sense the medium. At the end of that period and if the medium is still idle, the source node begins transmitting data packets. The random backoff period reduces the risk of collision between data packets transmitted by the given source node and other source nodes since the other source nodes waiting to access the medium are likely to use a different random backoff period.

It is to be recalled that the time unit in the 802.11 standard is the slot time generally called aSlotTime parameter. This parameter is specified by the physical layer (PHY). It is, for example, equal to 9 μs for the 802.11 n standard. All the dedicated time periods, for example SIFS, PIFS, and DIFS, are multiples of that time unit.

The Short Inter-Frame Space (SIFS) is used to separate a response frame from the frame that requested the response, for example between a data frame and the acknowledgement response. The SIFS is, for example, equal to 16 μs according to the 802.11n standard. The PCF Inter-Frame Space (PIFS) provides the next highest access priority time space after the SIFS time (PIFS=SIFS+aSlotTime). The DCF Inter-Frame Space (DIFS) defines the minimum waiting time, after detecting that a medium is idle, before a transmitting node can attempt to transmit data packets (DIFS=SIFS+2×aSlotTime). The different inter-frame space durations provide access to a wireless medium at different priority levels.

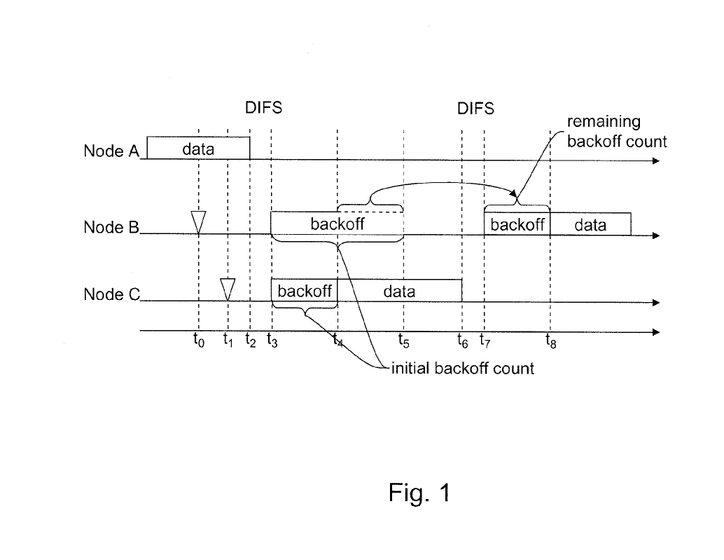

FIG. 1 is a time diagram illustrating the DCF and backoff access mechanism for accessing a communication medium for transmitting data packets. In the given example, three different source nodes, referred to as node A, node B, and node C, need to access the medium.

As depicted with triangular marks, node B needs to transmit data at time t₀ while node A is transmitting data packets. Similarly, node C needs to transmit data at time t₁ while node A is still transmitting data packets.

However, a node must first sense the medium over a DIFS duration before initiating any transmission on the wireless medium. If the wireless medium is still idle at the end of the DIFS duration, the transmitting node initiates its transmission process. To that end, it invokes a backoff procedure using a backoff counter to count down a backoff value (corresponding to a number of time slots) randomly obtained from a range defined by zero and a contention window (CW) value ([0; CW]).

It is to be noted that when the wireless medium goes from a busy to an idle state, several nodes may be ready to send data packets. To minimize collisions, the nodes that need to initiate data transfers select a random backoff value and defer communication for the corresponding number of time slots. The random backoff value is generally a pseudo-random integer determined according to a uniform distribution over the range [0, CW]. The contention window (CW) parameter varies from a minimum value (CWmin) to a maximum value (CWmax). According to the backoff mechanism, the contention window (CW) parameter doubles on each erroneous transmission, that is to say on each collision on the medium, until it reaches the CWmax value. It is reset to the CWmin value after each successful data transmission.

To begin the random backoff procedure in a node, the latter selects a random backoff value in the range [0, CW]. All backoff slots (of length aSlotTime) occur in the backoff window or contention window following a DIFS duration during which the medium is sensed to be idle. During each backoff slot, the node continues to sense the wireless medium. If the wireless medium becomes busy during a backoff slot, the backoff procedure is frozen until the wireless medium again becomes idle

Accordingly, returning to FIG. 1, node B is sensing the medium from time t₀ to detect its idle state. Likewise, node C is sensing the medium from time t₁. At time t₂, both nodes B and C determine that the medium is no longer busy. Therefore, at time t₃, that is to say after having determined that the medium is still idle at the end of the DIFS duration, the backoff value associated with each node waiting to transmit data (i.e., nodes B and C) is decreased until one of the values reaches zero. When a backoff value reaches zero, the corresponding node initiates a transmission.

When it is detected that the medium is no longer in its idle state, counting down the backoff value is suspended in each of those waiting nodes.

As shown in FIG. 1, the backoff values of nodes B and C are decreased from time t₃ until the medium is no longer in an idle state (or until one of the backoff values reaches zero since, in such a case, one of those waiting nodes accesses the medium that consequently is no longer in the idle state). For the sake of illustration, it is assumed that the backoff value associated with node C reaches zero at time t₄. Accordingly, node C can access the medium for transmitting data while counting down the backoff value associated with node B is suspended.

If collision occurs at time t₃, the transmitting node invokes a new backoff procedure by increasing the range of the collision window to determine a new number of backoff time slots (such procedure is called Exponential Backoff Algorithm in the standard).

Time t₅ designates here the time at which the backoff value associated with node B would have reached zero if it had not been suspended at time t₄. The value of the backoff value associated with node B at time t₄ is called the remaining backoff value.

When node C ceases to use the medium, at time t₆, node B determines that the medium is in an idle state. Accordingly, after the following DIFS duration (i.e. at time t₇), the backoff mechanism is invoked and the backoff value associated with node B is decreased (starting from its remaining value as illustrated) so that node B can access the medium if it is still in an idle state when the backoff value reaches zero (time t₈).

According to the example given with reference to FIG. 1, the node having the smallest backoff value (node C) wins the contention resolution mechanism and transmits its data packets first. The remaining nodes suspend their backoff procedure and resume with a DIFS time after the medium goes idle again. The node with the next smallest backoff value (node B) counts down the remaining backoff value and is the next to win the medium access.

Other techniques are provided in the art for scheduling the access to a communication medium.

The scheduling schemes are typically designed in order to fairly share wireless medium resources between nodes of a network and in order to maximize the medium throughput. The scheduling schemes typically consist in a sequential scheduling of time periods during which medium access is granted to one node at a time.

For instance, the IEEE 802.11s standard defines a distributed scheduling scheme known as the MDA (Mesh Deterministic Access) protocol.

The MDA protocol is a method of coordinating the transmissions of mesh nodes in an IEEE 802.11s mesh network using a distributed schedule. A transmission schedule is established between two mesh nodes when the devices identify an unreserved period of time, called a Mesh Deterministic Access opportunity (MDAOP), during which no other node has scheduled an access for data transmission. Next, both nodes warn the other nodes of the network that the identified MDAOP is reserved. This prevents the nodes nearby from reserving the medium during the communication between the two nodes that reserved the medium. A node making a reservation as a transmitter must start and complete its transmissions during the reserved period of time.

Another example is the Reverse Direction (RD) protocol defined by the IEEE 802.11n standard.

The RD protocol aims at efficiently transferring data between two IEEE 802.11n nodes (also called HT nodes in the standard, HT standing for High Throughput) during a TXOP (transmission opportunity) by eliminating the need for performing an access request for an HT node that has to transmit data in response to received data.

Before the implementation of the RD protocol, for each uni-directional data transfer (i.e. both the sender and the respondent), the initiating node had to reserve (and possibly reserve time on) a contention-based communication medium. With the RD protocol, once a transmitting node has obtained a TXOP, it may grant permission to the recipient node to send back information during the obtained TXOP period, without having to reserve its own TXOP period.

The response by the recipient node starts after a SIFS following the end of the frame sent by the RD initiating node with a Reverse Direction granting flag set to 1 (a specific field called RDG/More PPDU is present in the header of IEEE 802.11n/HT MAC frames). During a response burst, only the RD responding node may transmit (i.e., there is no transmission by any other node, including the RD initiating node).

The RD initiating node may transmit its next PPDU (Physical Protocol Data Unit, sent to or received from PHY layer of the OSI model) at least a SIFS period after receiving a response PPDU with the RDG/More PPDU field set to 0.

Another prior art method is disclosed by the published patent application US2005/0135318.

This document discloses a medium allocation for several nodes at a time. A node may request access to a shared medium according to a legacy protocol, and upon grant of access, the node may communicate with one or more remote nodes (or facilitate communication between two or more remote nodes) according to a new protocol. The new protocol may support a high data rate, a high bandwidth physical layer transport mechanisms, or other modulation techniques different from the legacy protocol.

In an Ad hoc environment, the method described in this document aims at bypassing some limitations of the IEEE 802.11n Reverse Direction protocol. The method according to this document allows transmissions from a same node to multiple destination nodes using consecutive transmissions inside a same TXOP period, by eliminating many or all of the guard periods and reducing the preamble overhead.

Regarding an infrastructure environment, this document discloses an extension of the IEEE 802.11 standard HCCA (Hybrid Coordination Function Controlled Channel Access) and EDCA (Enhanced Distributed Channel Access). A scheduler at an access point (AP) may poll several nodes during a medium access period, called Scheduled Access Period (SCAP). This is to put in perspective with the IEEE 802.11 Hybrid Coordination Function (HCF) which introduces a Controlled Access Phase (CAP), in which the inter-frame spacing is a SIFS.

By using SCAP periods, an AP node transmits fixed assignments for AP to node, node to AP and node to node transmissions in a header frame (the SCHED frame) for the duration of a SCAP, thus avoiding unnecessary polling, contention and IFS (InterFrame space). In this document, no scheduling technique is disclosed for determining the assignment and duration values of transmissions, filled in the header frame.

As a result, this document focuses on avoiding unnecessary waste of time in polling, contention, etc. due to the inherent IEEE 802.11 medium, by providing a method for contenting an IEEE 802.11 medium access timeslot and transmitting inside that timeslot in a different modulation at the physical layer (PHY). In Ad hoc mode, contention is still IEEE 802.11 classical. In an infrastructure mode, the AP uses a proprietary mode.

Thus, in the current art, there is no distributed scheduling method that allows efficient sharing of a CSMA/CA medium (like in the IEEE 802.11 standard) between nodes of a group in a pure Ad hoc environment (with no centralized controller).

According to a first aspect of the invention there is provided a method of accessing a communication medium used by a plurality of communication terminals, comprising the following steps, performed by a first communication terminal belonging to a group of communication terminals from the plurality of communication terminals:
detecting an upcoming reservation, by a second communication terminal of the group, of an occupancy time interval of the communication medium,
determining a timeslot in the occupancy time interval, and
transmitting data over the communication medium during the determined timeslot.

A communication terminal may be also referred to as a node.

For example, the determining step comprises performing calculations by the first terminal.

For example, the communication medium is accessed according to a Carrier Sense Multiple Access with Collision Avoidance (CSMA/CA) technique.

With conventional wireless systems using techniques to provide medium access of the CSMA/CA type, only one particular node is allowed to transmit data during a specified period of time. Also, each node gets access to the node randomly. Thus, such a random, performed on a station basis, allocation provides an inefficient use of the medium, for example, when the node belongs to a group of nodes exchanging highly interactive data. Indeed, the communication between two nodes of the same group may be interrupted by an access to the medium by a node not belonging to the group. Thus, the overall efficiency of the communication within the group is affected.

Hence, embodiments of the invention provide, notably for sub-groups of nodes of an ad hoc network, a means for sharing the access to a communication medium while notably providing a low-latency delivery, a reduced number of accesses to contented medium, a distributed scheduling thereby allowing regular data transfers.

Embodiments of the invention are backward compatible and interoperable with legacy IEEE 802.11 systems.

Embodiments of the present invention enhance the performance of a communication network by sharing a medium access between communication nodes of a group of communication nodes.

When a node of a group is granted access to the communication medium, it may allocate a part of its access to other nodes in the group.

The occupancy time intervals of the communication medium reserved by communication terminals may correspond to TXOP durations.

For instance, each node of a group may allocate a timeslot of an already obtained TXOP. Thus, contention accesses may be avoided for the nodes of the group.

The duration of allocated timeslots may be determined based on the backoff count of each node in the group.

According to embodiments of the invention, end-to-end jitter is reduced.

Also, the buffer size of each communication terminal may be reduced. Thus, the average time spent by data in the buffer is also reduced, since the access to the communication medium is regular for the communication nodes.

Embodiments of the invention may be fully compliant with already existing networks such as IEEE 802.11 Ad hoc networks.

Embodiments of the invention allow a further support of efficient TDMA (Time Division Multiple Access). Indeed, there may be no SIFS interspace nor transmitter grant between each node access, like in the MDA protocol.

Embodiments of the invention allow N to N communication (TDMA-like).

Embodiments of the invention reduce end-to-end average delay. Indeed, unnecessary delays during medium access may be avoided. For example, EDCA and HCCA consume a lot of time in determining whether the medium is busy.

In an embodiment, the first and second communication terminals belong to a group of communication terminals exchanging interactive data between one another over the communication medium.

Such communication terminals may especially need to transmit data between them is a short period of time. Thus, it may be desirable for them not to have their communications interrupted by the access of a communication terminal, not belonging to their group, to the communication medium.

In an embodiment, the occupancy time interval is determined according to a number of communication terminals in the group of communication terminals.

Thus, the occupancy time interval may be adapted for enabling each communication terminal of the group to transmit data. The risk of having the reserved occupancy time interval not being enough for enabling each communication terminal to transmit data may be reduced. For example, the occupancy time interval may be an increasing function of the number of communication terminals in the group.

In an embodiment, the timeslot is determined according to a bitrate of at least one communication terminal in the group.

Thus, the timeslot is adapted to the communication capacity of the communication terminal. For example, if a communication terminal has a low bitrate, it may need more time for transmitting data and if a communication terminal has a high bitrate, it may need less time.

In an embodiment, the timeslot is determined according to a first amount of data to be transferred by said at least one communication terminal in the group since a last access to the communication medium.

Thus, the timeslot takes into account the data transfer process of the communication terminal. For example, if a large amount of data is waiting for transmission by a given communication terminal, priority may be granted to that communication terminal.

In an embodiment, the last access to the communication medium is estimated according to a last access to the communication medium by a communication terminal of the group.

Thus, the overall amount of data to be transferred by all the communication terminals of the group is taken into account.

In an embodiment, the timeslot is determined according to a second amount of data that is expected to be transferred at a next request for access to the communication medium by at least one communication terminal in the group.

Thus, the data transfer process is taken into account in a predictive fashion.

In an embodiment, the timeslot is determined according to a data buffer size of at least one terminal in the group.

The data buffer size may be an effective means for assessing the data that is waiting for transfer.

In an embodiment, the timeslot is determined according to a physical data rate over the communication medium.

The physical data rate may be an effective means for assessing the transmission capabilities of the communication terminals.

In an embodiment, the occupancy time interval is determined according to a maximum occupancy time interval available on the communication medium.

Thus, there is no need to compute the occupancy time interval and the probability of having each communication terminal transmit data during this time interval is high.

In an embodiment, each communication terminal of the plurality of communication terminals performs a backoff algorithm for obtaining access to the communication medium.

Using a backoff procedure may reduce the risk of having communication terminals accessing the communication medium at a same time.

In an embodiment, the first communication terminal stores a table comprising current backoff values of the communication terminals in the group.

Thus, the communication terminal may be aware of the next communication terminal that is likely to reserve an occupancy time interval on the communication medium.

In an embodiment, the method further comprises a step of receiving a backoff value from a communication terminal of the group of communication terminals.

The exchange of the backoff values between the communication terminals may provide reliable information on the likelihood of a reservation of an occupancy time interval on the communication medium.

In an embodiment, the received backoff value is an initial backoff value, and the first communication terminal performs a countdown from said initial backoff value for determining the current backoff value of the communication terminal from which it received the initial backoff value.

Thus, the backoff value communications are reduced which makes the communication bandwidth of the communication terminals less loaded.

In an embodiment, the received backoff value is a current backoff value.

Thus, the first communication terminal has less computation to perform for knowing the current backoff values of the other communication terminals and determining the next communication terminal that is likely to reserve an occupancy time interval on the communication medium.

In an embodiment, the second amount of data is the amount of data that would be transferred at the bitrate of a terminal of the group during a period corresponding to N times the maximum occupancy time interval available on the communication medium, N being the least current backoff value from the backoff values of the communication terminals of the group.

In an embodiment, the method further comprises outputting a message indicating that the communication medium is reserved by the second communication terminal for said occupancy duration.

Thus, each communication terminal may be informed of the reservation and each terminal may suspend its backoff countdown thus avoiding the risk of collision.

In an embodiment, the determination of the timeslot comprises dividing the sum of the first and second amount of data by the physical data rate.

According to a second and a third aspect of the invention, there are provided computer programs and computer program products comprising instructions for implementing methods according to the first aspect of the invention, when loaded and executed on computer means of a programmable apparatus such as a communication terminal.

According to an embodiment, an information storage means readable by a computer or a microprocessor stores instructions of a computer program, that it makes it possible to implement a method according the first aspect of the invention.

According to a fourth aspect of the invention there is provided communication terminal comprising:
an interface for communicating over a communication medium used by a plurality of communication terminals, and
a control unit configured for detecting an upcoming reservation, by another terminal of a group of communication terminals from the plurality of communication terminals, said communication terminal and said another communication terminal both belonging to the group of communication terminals, the control unit being further configured for determining a timeslot in the occupancy time interval and for transmitting data over the communication medium during the determined timeslot.

For example, in order to determine the timeslot, the control unit is further configured for performing calculations.

For example, communication over the communication medium is performed according to a Carrier Sense Multiple Access with Collision Avoidance (CSMA/CA) technique.

In an embodiment, the communication terminal and said another communication terminal belong to a group of terminals exchanging interactive data between one another over the communication medium.

In an embodiment, the control unit is further configured for determining the occupancy time interval according to a number of communication terminals in the group of communication terminals.

In an embodiment, the control unit is further configured for determining the timeslot according to a bitrate of at least one communication terminal in the group.

In an embodiment, the control unit is further configured for determining the timeslot according to a first amount of data to be transferred by said at least one communication terminal in the group since a last access to the communication medium.

In an embodiment, the control unit is further configured for estimating the last access to the communication medium according to a last access to the communication medium by a communication terminal of the group.

In an embodiment, the control unit is further configured for determining the timeslot according to a second amount of data that is expected to be transferred at a next request for access to the communication medium by at least one communication terminal in the group.

In an embodiment, the control unit is further configured for determining the timeslot according to a data buffer size of at least one communication terminal in the group.

In an embodiment, the control unit is further configured for determining the timeslot according to a physical data rate over the communication medium.

In an embodiment, the control unit is further configured for determining the occupancy time interval according to a maximum occupancy time interval available on the communication medium.

In an embodiment, each communication terminal of the plurality of communication terminals performs a backoff algorithm for obtaining access to the communication medium.

In an embodiment, the communication terminal further comprises a memory unit for storing a table comprising current backoff values of the communication terminals in the group.

In an embodiment, the control unit is further configured for receiving a backoff value from a communication terminal of the group of communication terminals.

In an embodiment, the received backoff value is an initial backoff value, and the control unit is further configured for performing a countdown from said initial backoff value for determining the current backoff value of the communication terminal from which it received the initial backoff value.

In an embodiment, the received backoff value is a current backoff value.

In an embodiment, the second amount of data is the amount of data that would be transferred at the bitrate of a communication terminal of the group during a period corresponding to N times the maximum occupancy time interval available on the communication medium, N being the least current backoff value from the backoff values of the communication terminals of the group.

In an embodiment, the control unit is further configured for outputting a message indicating that the communication medium is reserved by said another communication terminal for said occupancy duration.

In an embodiment, the control unit is further configured for determining the timeslot by dividing the sum of the first and second amount of data by the physical data rate.

The objects according to the second, third and fourth aspects of the invention provide at least the same advantages as those provided by the method according the first aspect of the invention.

According to a fifth aspect of the invention, there is provided a method of data communication in a communication network, said network comprising at least one group of communication terminals, wherein, when a communication terminal of the group is about to reserve an occupancy time interval, each of a plurality of communication terminals of said at least one group performs a method according to the first aspect in order to determine a respective timeslot in the time occupancy interval.

According to a sixth aspect of the invention, there is provided a communication system comprising a group of communication terminals according to the fourth aspect, wherein each communication terminal of a plurality of terminals of the system is configured to determine a respective timeslot in an occupancy time interval that is to be reserved by a communication terminal of the system

Other features and advantages of the invention will become apparent from the following description of non-limiting exemplary embodiments, with reference to the appended drawings, in which, in addition to FIG. 1:

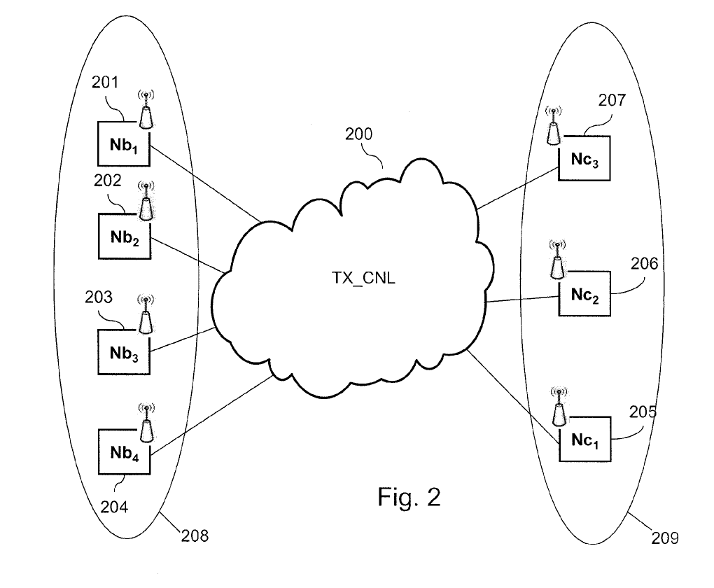

FIG. 2 illustrates a context of implementation of embodiments of the invention;

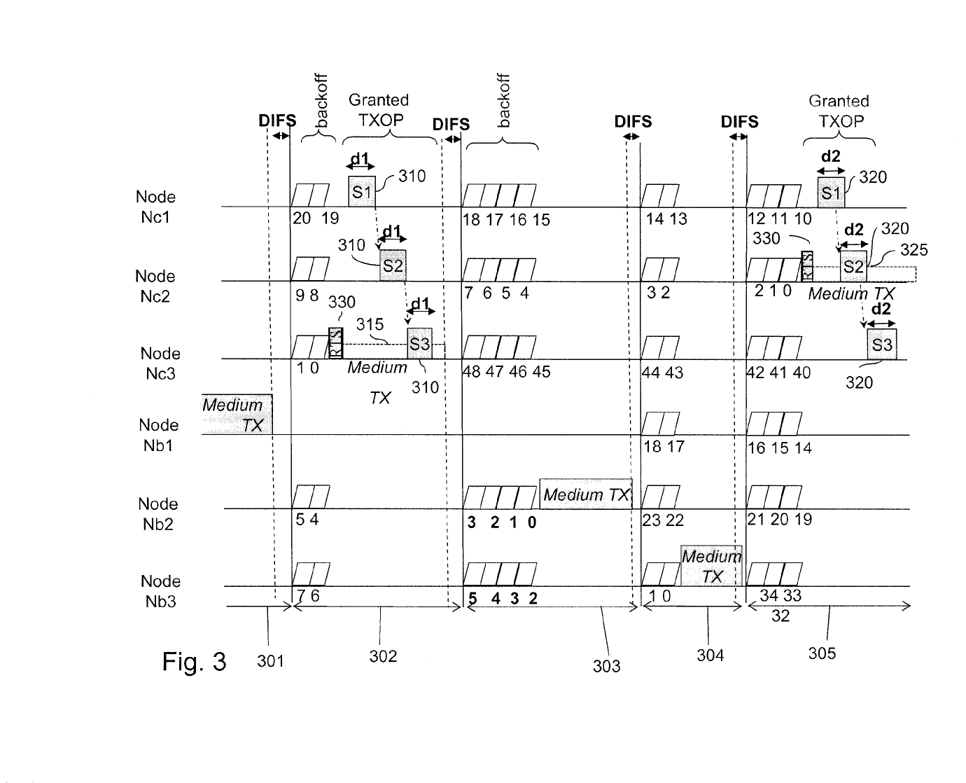

FIG. 3 is a time diagram showing successive periods of occupation of a communication medium;

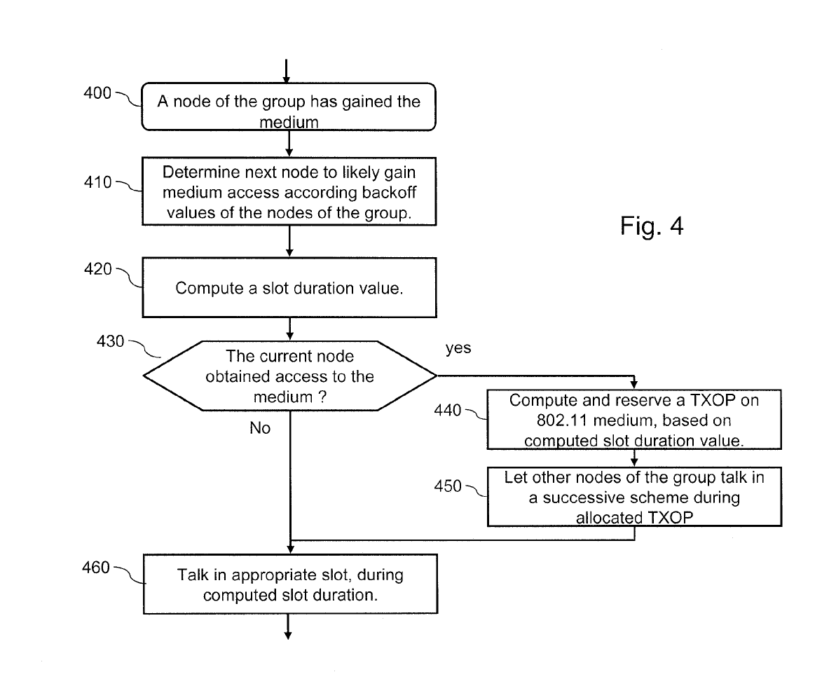

FIG. 4 is a general flowchart of steps performed during a method according to an embodiment;

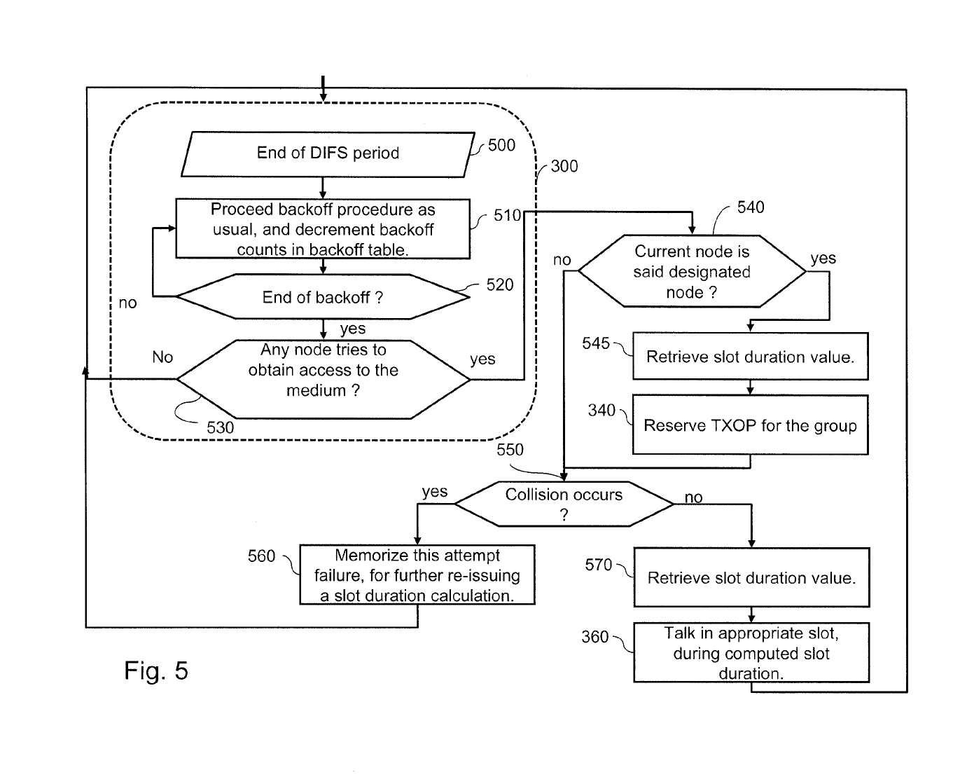

FIG. 5 is a detailed flowchart of steps performed during a method according to an embodiment;

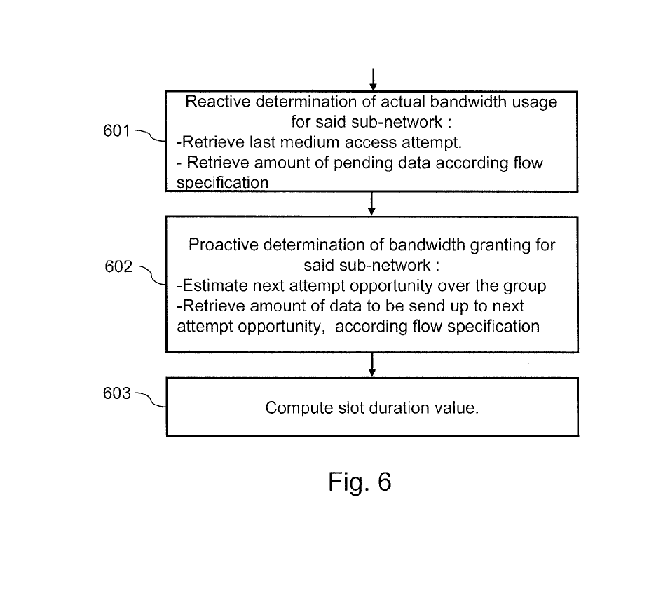

FIG. 6 is a flowchart of steps performed for determining a timeslot duration according to an embodiment;

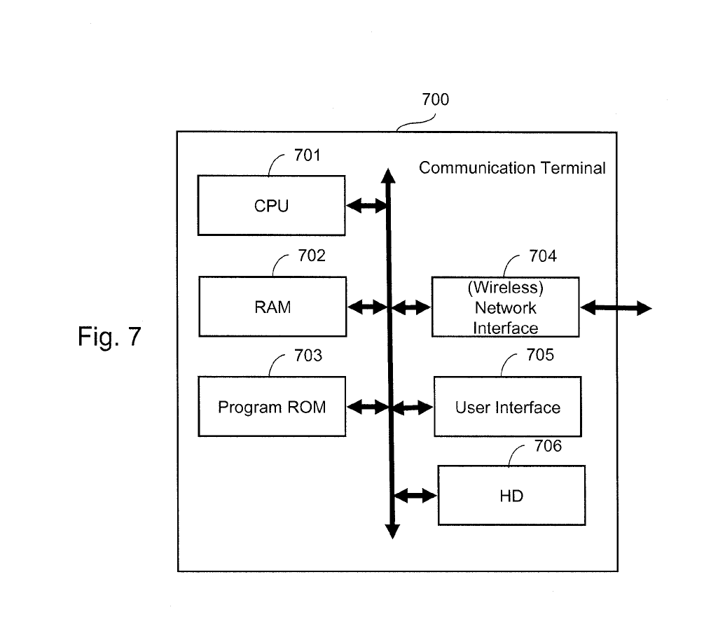

FIG. 7 is a schematic illustration of a terminal according to an embodiment.

In broad terms, embodiments the invention aim at organizing the access to a shared communication medium in a communication network, notably networks wherein the access is provided to communication terminal at random. The invention enables sharing a transmission opportunity between several terminals while optimizing the duration of timeslots allocated to the sharing terminals in the transmission opportunity.

FIG. 2 is an illustration of a context of implementation of embodiments of the invention. Communication terminals (referred to as nodes in what follows) 201 to 207 (respectively referred to as Nb1, Nb2, Nb3, Nb4, Nc1, Nc2 and Nc3 in what follows) of a communication network (not represented) exchange data through a communication medium (or communication channel) 200.

For example, the nodes exchange data through a network implementing a CSMA/CA (Carrier Sense Multiple Access with Collision Avoidance) medium access mechanism. For example, the network is a wireless network, e.g. a Wireless Local Area Network (WLAN), implementing the IEEE 802.11 standard.

Nodes 201 to 204 are part of a first group 208 and nodes 205 to 207 are part of a second group 209. The nodes belonging to the second group may exchange interactive data between them. The number of nodes and the number of groups should not be construed as limitative. There may be another number of nodes and they may be divided into another number of groups.

According to the methods of the prior art, each node has to reserve the communication medium for its own data transmissions, the reservation being performed at a random instant, for example using backoff procedures.

According to the invention, a communication node, for example a node of the second group, can reserve the communication medium for several nodes, for example of the second group. Thus, the communication of data between the nodes of the second group may not be interrupted by the random access to the communication medium by a node of the network not belonging to the second group.

FIG. 3 illustrates five successive phases 301 to 305 (from left to right), corresponding to successive medium accesses to the communication medium. According to the IEEE 802.11 standard, the release of the communication medium by a communication node and the beginning of the backoff (or countdown) procedures by the other communication nodes of the network are separated by a DIFS interval (DIFS stands for DCF lnterframe Space and DCF stands for Distributed Coordination Function in the IEEE 802.11 standard).

During phase 301, node Nb1 has reserved the communication medium in order to transmit data. Next, node Nb1 releases the communication medium and, after a DIFS period, other nodes check whether the communication medium is idle (which means free). Since this is the case here, each node Nc1, Nc2, Nc3, Nb2 and Nb3 starts a backoff procedure. It is assumed for the illustration that node Nb1 has no more data to transmit so it does not start a backoff procedure in order to access the IEEE 802.11 medium.

Thus, at the beginning of phase 302, each node starts decrementing its own backoff value. For the sake of illustration, nodes Nc1, Nc2, Nc3, Nb2 and Nb3 respectively start from the values “21”, “10”, “2”, “6” and “8”. After two decrements, node Nc3 has a backoff value of “0”.

Hence, in order to avoid access conflicts, node Nc3 checks whether the communication medium is still idle. Since, the medium is free and node Nc3 is the only node having a backoff value of “0”, it reserves the communication medium for an occupancy time interval which is, in the present example, a TXOP (Transmit Opportunity) duration 315.

The TXOP duration comprises several timeslots 310 for data transmission by each node of the group 209 to which node Nc3 belongs. In the present example, three timeslots S1, S2 and S3 allow data exchange between nodes Nc1, Nc2 and Nc3 of the group 209. The timeslots may have different durations. However, in the present example, the timeslots have a same duration d1 which may be computed in advance as it will be further described below.

For example, the TXOP duration 315 corresponds to a duration a node should wait before trying to get access to the medium. For instance, the TXOP duration depends on the number of nodes in the group 209, according to the following formula:

TXOP duration=RTS_duration+SIFS+CTS_duration+SIFS+N×(slot_duration+guard),

where:
RTS_duration, CTS_duration are IEEE 802.11 duration values for respectively transmitting RTS (Request to Send) and CTS (Clear to Send) frames, depending on the IEEE 802.11 PHY modulation,
SIFS represents a Short lnterframe Space duration according to the IEEE 802.11 standard,
N is a number of nodes forming the group 209,
timeslot_duration is a duration of a current timeslot,
guard represents a time interval between timeslots.

The maximum limit for the guard time intervals is less than a SIFS so as not to let any IEEE 802.11 node detect a change of medium owner during the TXOP duration. The SIFS is used to separate individual frames in the IEEE 802.11 standard without the inter-frame interval being interpreted by the nodes as a change of medium owner. According to the accuracy of the clocks of the nodes in the group, the guard interval may be close to several microseconds.

According an optional embodiment, the TXOP duration may be the TxopLimit value of the IEEE 802.11 standard. The TxopLimit value is the maximum occupancy duration allowed for the communication medium.

When a node reserves the communication medium, it outputs an RTS frame for informing the other nodes that the communication medium is occupied.

Thus, Node Nc3 issues a data packet that carries the expected duration of the data transmission. The computed TXOP duration is incorporated in the Duration field of an RTS frame.

As illustrated in FIG. 3, an RTS message 330 is issued by the node Nc3 which accessed the communication medium (the corresponding CTS message is not represented in the figure) in order to inform the other nodes.

The timeslots S1 and S2 are respectively assigned to the nodes Nc1 and Nc2 and timeslot S3 is assigned to node Nc3.

Once the TXOP period ends, nodes Nc1, Nc2 and Nc3 have transmitted data during the respective timeslots S1, S2 and S3. The communication medium is then released.

However, during the entire TXOP duration 315, the communication medium is seen by nodes Nb1, Nb2 and Nb3 as occupied by node Nc3. Thus, they will not try to access the communication medium during that period and they will not prevent the nodes Nc1, Nc2 and Nc3 from communicating over the communication medium, for example by provoking collision cases.

Next, after a DIFS period, phase 303 starts. Each node having data to transmit starts a backoff procedure. Nodes Nc1, Nc2, Nc3, Nb2 and Nb3 continue the previous backoff procedure since their backoff values did not reach “0”. We assume that node Nb1 has no data to transmit and thus, that it does not start a backoff procedure. We also assume that node Nc3 still has data to transmit so it starts a new backoff procedure with a new random initial backoff value.

At the beginning of phase 303, each node starts decrementing its own backoff value. Nodes Nc1, Nc2, Nb2 and Nb3 respectively start from their previous backoff value equal to “19”, “8”, “4” and “6” while node Nc3 starts from its new random backoff value equal to “49” in this example. After four decrements, node Nb2 has a backoff value of “0”.

Thus, node Nb2 accesses the communication medium.

After node Nb2 has transmitted its data, the communication medium is released and after a new DIFS period, phase 304 begins. We assume that nodes Nb1 and Nb2 start new backoff procedures with new initial backoff values.

At the beginning of phase 304, each node starts decrementing its own backoff value. Nodes Nc1, Nc2, Nc3, Nb1, and Nb3 respectively start from their previous backoff values “15”, “4”, “45”, “19”, and “2” while node Nb2 starts from its new backoff value “24”. After two decrements, node Nb3 has a backoff value of “0”.

Thus, node Nb3 accesses the communication medium.

After node Nb3 has transmitted its data, the communication medium is released and after a new DIFS period, phase 305 begins. We assume that node Nb3 starts a new backoff procedure with a new initial backoff value.

At the beginning of phase 305, each node starts decrementing its own backoff value. Nodes Nc1, Nc2, Nc3, Nb1 and Nb2 respectively start from their previous backoff values equal to “13”, “3”, “43”, “16” and “21” while node Nb3 starts from its new backoff value “35”. After three decrements, node Nc2 has a backoff value of “0”.

Thus, according to the present embodiment, it reserves the communication medium for the group 209 of nodes Nc1, Nc2 and Nc3 by issuing an RTS message and by assigning timeslots 320 to the other nodes of the group.

The duration d2 of the timeslots 320 may not be the same as the duration of the timeslots 310. The computation of durations d1 and d2 will be further described below, with reference to FIGS. 4 and 5.

With the present embodiment, the medium can be accessed regularly/smoothly by the nodes, while considering having different talk duration each time.

In FIG. 3, the current backoff values are represented during backoff periods under each backoff timeslot of a given node.

In order to know whether a node has to reserve the communication medium for itself only or for several nodes, each node of the second group 209 is able to know if any other node of the group is about to try to access the medium.

For example, each node contains a backoff table storing the current backoff value used by each node.

One node knows its own backoff value for the current timeslot, and the backoff values of the other nodes in the group.

For example, the nodes may exchange their current backoff values between them or each node may store the initial backoff values of the other nodes and decrement them. Thus, a current node may know when a node has its backoff value set to “0” and that it is likely to request access to the communication medium.

Steps performed by the nodes of the second group 209 are described with reference to FIG. 4.

After the communication medium has been sensed as idle and after the DIFS period, the nodes proceed to a backoff procedure.

Also, the nodes of the group 209 exchange their backoff values with the other nodes of the group, using any known protocol. For instance, the backoff value may be exchanged according to a method as disclosed in the published patent application US20090141738. As a result, each node of the group 209 is able to determine the backoff values of the other nodes of the group for each timeslot duration following a DIFS period.

Next, a node implementing the present invention accesses the communication medium during a step 400. Typically, such a node has a backoff value that reached “0”, and the other nodes of the group 209 are aware about that.

After that, each node of the group of nodes 209 determines which node of the group is likely to access the communication medium using the previously exchanged backoff values during step 410.

In order to assign a timeslot to each node of the group, a timeslot duration is computed during step 420 using the backoff values previously exchanged. As discussed above, the timeslots are used by each node of the group for transmitting data over the communication medium.

In a preferred embodiment, the computation may take into account the potential next access to the communication medium for the whole group in order to size the timeslot duration of each node of the group. This computation may be refined, as further explained with reference to FIG. 6, by including events from the past.

Next, the node checks which node is getting access to the communication medium.

If the node to access the communication medium is the current node, it reserves a transmission opportunity (TXOP) over the communication medium during step 440, in order to have the nodes of the group successively transmitting their data related to the computed timeslot duration.

Each node may be assigned a timeslot index indicating the timeslot during which it may talk (e.g. according to a growing numbering of node identifiers, etc.).

Next, the node lets the other nodes of the group transmit data during their assigned timeslot during step 450.

Also, the node transmits its own data during step 460.

If, during step 430, the node determines that another node (i.e. not the node itself) is to get access to the communication medium, the process goes directly to step 460 during which it transmits its own data in the appropriate timeslot.

According to embodiments, steps 410 and 420 are not performed after step 400. For example, steps 410 and 420 are performed in advance, so that the timeslot duration is already computed before next time it will be used.

Hence, once the backoff value of the node reaches “0”, there is no delay before transmitting data or before an RTS frame.

FIG. 5 is a more detailed flowchart of steps performed by the communication nodes.

Step 500 corresponds to the end of a DIFS period and the initiation of a backoff procedure.

In order to be aware of any node of the group 209 that is about to request access to the medium, the decrement of the backoff values for all nodes in the group is performed along with the decrement of the own backoff value of the node during step 510.

Next, after a timeslot duration, it is checked during step 520 whether the backoff period has to be stopped. The backoff period is stopped in case a node has accessed the medium (for example, a node out of the group 209), or in case the backoff value of any node in group 209 has reached “0”.

If the backoff period continues, the process goes back to step 510. If the backoff period is stopped, then the process goes to step 530 during which it is checked whether a node of the group 209 is trying to get access to the communication medium (for example because this node has a backoff value that has reached “0”).

If there is no node of the group 209 that is trying to get access to the communication medium, the process goes back to step 500.

If a node of the group 209 tries to get access to the communication medium, the process goes to step 540 during which it is checked whether the current node is the node trying to get access to the communication medium.

For instance, if the backoff value that reached “0” belongs to the current node implementing the process, then, the current node retrieves a timeslot duration value for the nodes in the group during step 545 and reserves a TXOP duration during step 340.

Next, the process goes to step 550 in order to check whether a collision occurs, that is to say whether two nodes are requesting access to the communication medium at the same time.

If, during step 540, it is determined that the backoff value that reached “0” belongs to another node, the process goes directly to step 550.

If no collision is detected during step 550, the process goes to step 570 during which the node retrieves a timeslot duration value and step 360 during which it transmits its own data during said timeslot. Step 570 may be optional if the timeslot value for the current node has already been retrieved.

If a collision is detected, the process goes to step 560 during which the node memorizes the failure for taking it into account for the next timeslot duration computation.

With reference to FIG. 6, there is described below a computation of timeslot durations by a node.

This computation may take into account the bitrates of the data streams at each node of the group and the forecast date at which the nodes are likely to get access to the communication medium (given their backoff values).

In the present description, it is assumed that the CBR (Constant Bit Rate) data stream is identical for all nodes of the group, that is to say that the bitrate is the same for all the nodes of group 209. However, the CBR may be different from one node to another.

During step 601, the node determines, for one or more node of the group, an amount of data to be transferred since the last access to the medium. This is a reactive action from the past behavior. For example, the determination may comprise estimating the buffer occupancy at a sending node. Since we consider a CBR traffic identical for all nodes in the group, knowing the CBR stream's bitrate allows a direct determination of the amount of data waiting at each node in the group since the last successful medium access. The amount of data to be transferred (for example the data waiting in queues of the nodes in the group) may be determined according to the following formula:

Reactive_Data_Amount=delay×application_rate,

where:
“Delay” is the time elapsed since last medium access for the group that is to say the time elapsed since last medium access of a node of the group, and
“application_rate” is the bitrate of the data stream.

Next, during step 602, the node determines, for one or more node in the group, the amount of data that will be to transfer from a current instant and the next time the node will try to access the communication medium. This is a pro-active determination. This may be determined since the nodes of the group know the respective backoff values of the nodes.

The time that will elapse until the next potential opportunity to access the communication medium may be determined according to the following formula:

Opportunity_timing=Nxt_backoff×TXOPLimit,

where:
“Nxt_backoff” is the least backoff value among the current backoff values of the nodes in the group (for example this value is selected in the backoff table), and
“TXOPLimit” is the maximum TXOP duration allowable according to the IEEE 802.11 standard.

Back to FIG. 3, when phase 302 ends, a new computation should be performed. In that case, each node in the group 209 considers that the next node in the group that will try to get access to the communication medium is node Nc2, since the corresponding backoff value is 7 (i.e. the least backoff value among the nodes Nc1, Nc2 and Nc3 respectively having “18”, “7” and “48” as current backoff values). Thus, in the example of FIG. 3, the Opportunity_timing would be 7×TXOPLimit.

The amount of data expected for transfer may be determined according to the following formula:

Proactive_Data_Amount=Opportunity_timing×application_rate

The timeslot duration is then determined during step 603 according to the following formula:

$$timeslot\_duration = \frac{reactive\_Data \_Amount + proactive\_Data \_Amount}{PHY\_rate} ,$$

where:
PHY_rate is the physical rate used inside the granted TXOP. It may not be linked to the IEEE 802.11 physical rate, for example if another modulation is used inside the granted TXOP.

If the TXOP duration is not enough for transmitting the data to be transferred, overloading data may be discarded at emission buffer of each node in the group.

For example, this case occurs when timeslot_duration is larger than the maximum timeslot value, which is determined according to the following formula:

$$max\_timeslot \_duration = \frac{TxopLimit - N \times guard}{N} .$$

The exceeding amount of data would be determined according to the following formula:

$$\frac{calculated\_timeslot \_duration - max\_timeslot \_duration}{PHY\_rate} .$$

A computer program according to embodiments may be designed based on the flowcharts of FIGS. 4, 5 and 6 and the present description.

FIG. 7 is a schematic illustration of a communication terminal (or node) 700 according to an embodiment. This communication terminal may communicate with other terminals over a transmission medium 200 as described above. The terminal comprises a RAM (Random Access Memory) unit 702 for storing processing data used for computations for implementing a method according to embodiments. The terminal may also comprise a ROM (Read Only Memory) unit 703 for storing a computer program according to an embodiment. The ROM unit may also store the backoff value of the terminal and/or the backoff values received from other terminals. The terminal further comprises a control unit 701. The control unit may comprise a processor configured for implementing a method according to an embodiment, for example by executing instructions of a computer program according to embodiments. The computer program may be loaded from the ROM unit 703 or a hard-disc 706. The terminal further comprises a network interface 204 for communicating over the communication medium. The network interface allows the connection of the terminal to the communication medium. Data packets are transmitted through the network interface for transmission or read from the network interface for reception under the control of the control unit. The terminal may further comprise a user interface 705 for displaying information to a user and/or receive inputs from the user.

While the invention has been illustrated and described in detail in the drawings and foregoing description, such illustration and description are to be considered illustrative or exemplary and not restrictive, the invention being not restricted to the disclosed embodiment. Other variations to the disclosed embodiment can be understood and effected by those skilled in the art in practicing the claimed invention, from a study of the drawings, the disclosure and the appended claims.

In the claims, the word “comprising” does not exclude other elements or steps, and the indefinite article “a” or “an” does not exclude a plurality. A single processor or other unit may fulfil the functions of several items recited in the claims. The mere fact that different features are recited in mutually different dependent claims does not indicate that a combination of these features cannot be advantageously used. Any reference signs in the claims should not be construed as limiting the scope of the invention.

1. A method of accessing a communication medium used by a plurality of communication terminals, comprising the following steps, performed by a first communication terminal belonging to a group of communication terminals from the plurality of communication terminals:
detecting an upcoming reservation, by a second communication terminal of the group, of an occupancy time interval of the communication medium,
determining a timeslot in the occupancy time interval, and
transmitting data over the communication medium during the determined timeslot.

2. A method according to claim 1, wherein the first and second communication terminals belong to a group of communication terminals exchanging interactive data between one another over the communication medium.

3. A method according to claim 1, wherein the occupancy time interval is determined according to a number of communication terminals in the group of communication terminals.

4. A method according to claim 1, wherein the timeslot is determined according to a bitrate of at least one communication terminal in the group.

5. A method according to claim 4, wherein the timeslot is determined according to a first amount of data to be transferred by said at least one communication terminal in the group since a last access to the communication medium.

6. A method according to claim 5, wherein the last access to the communication medium is estimated according to a last access to the communication medium by a communication terminal of the group.

7. A method according to claim 4, wherein the timeslot is determined according to a second amount of data that is expected to be transferred at a next request for access to the communication medium by at least one communication terminal in the group.

8. A method according to claim 1, wherein the timeslot is determined according to a data buffer size of at least one terminal in the group.

9. A method according to claim 1, wherein the timeslot is determined according to a physical data rate over the communication medium.

10. A method according to claim 1, wherein the occupancy time interval is determined according to a maximum occupancy time interval available on the communication medium.

11. A method according to claim 1, wherein each communication terminal of the plurality of communication terminals performs a backoff algorithm for obtaining access to the communication medium.

12. A method according to claim 11, wherein the first communication terminal stores a table comprising current backoff values of the communication terminals in the group.

13. A method according to claim 11, further comprising a step of receiving a backoff value from a communication terminal of the group of communication terminals.

14. A method according to claim 13, wherein the received backoff value is an initial backoff value, and wherein the first communication terminal performs a countdown from said initial backoff value for determining the current backoff value of the communication terminal from which it received the initial backoff value.

15. A method according to claim 13, wherein the received backoff value is a current backoff value.

16. A method according to claim 11, wherein the second amount of data is the amount of data that would be transferred at the bitrate of a terminal of the group during a period corresponding to N times the maximum occupancy time interval available on the communication medium, N being the least current backoff value from the backoff values of the communication terminals of the group.

17. A method according to claim 1 further comprising outputting a message indicating that the communication medium is reserved by the second communication terminal for said occupancy duration.

18. A method according to claim 5 wherein the determination of the timeslot comprises dividing the sum of the first and second amount of data by the physical data rate.

19. (canceled)

20. An information storage means readable by a computer or a microprocessor storing instructions of a computer program, characterized in that it makes it possible to implement a method according to claim 1.

21. A communication terminal comprising:
an interface for communicating over a communication medium used by a plurality of communication terminals, and
a control unit configured for detecting an upcoming reservation, by another terminal of a group of communication terminals from the plurality of communication terminals, said communication terminal and said another communication terminal both belonging to the group of communication terminals, the control unit being further configured for determining a timeslot in the occupancy time interval and transmitting data over the communication medium during the determined timeslot.

22. A communication terminal according to claim 21, wherein the communication terminal and said another communication terminal belong to a group of terminals exchanging interactive data between one another over the communication medium.

23. A communication terminal according to claim 21, wherein the control unit is further configured for determining the occupancy time interval according to a number of communication terminals in the group of communication terminals.

24. A communication terminal according to claim 21, wherein the control unit is further configured for determining the timeslot according to a bitrate of at least one communication terminal in the group.

25. A communication terminal according to claim 24, wherein the control unit is further configured for determining the timeslot according to a first amount of data to be transferred by said at least one communication terminal in the group since a last access to the communication medium.

26. A communication terminal according to claim 25, wherein the control unit is further configured for estimating the last access to the communication medium according to a last access to the communication medium by a communication terminal of the group.

27. A communication terminal according to claim 24, wherein the control unit is further configured for determining the timeslot according to a second amount of data that is expected to be transferred at a next request for access to the communication medium by at least one communication terminal in the group.

28. A communication terminal according to claim 21, wherein the control unit is further configured for determining the timeslot according to a data buffer size of at least one communication terminal in the group.

29. A communication terminal according to claim 21, wherein the control unit is further configured for determining the timeslot according to a physical data rate over the communication medium.

30. A communication terminal according to claim 21, wherein the control unit is further configured for determining the occupancy time interval according to a maximum occupancy time interval available on the communication medium.

31. A communication terminal according to claim 21, wherein each communication terminal of the plurality of communication terminals performs a backoff algorithm for obtaining access to the communication medium.

32. A communication terminal according to claim 31, further comprising a memory unit for storing a table comprising current backoff values of the communication terminals in the group.

33. A communication terminal according to claim 31, wherein the control unit is further configured for receiving a backoff value from a communication terminal of the group of communication terminals.

34. A communication terminal according to claim 33, wherein the received backoff value is an initial backoff value, and wherein the control unit is further configured for performing a countdown from said initial backoff value for determining the current backoff value of the communication terminal from which it received the initial backoff value.

35. A communication terminal according to claim 33, wherein the received backoff value is a current backoff value.

36. A communication terminal according to claim 27, wherein the second amount of data is the amount of data that would be transferred at the bitrate of a communication terminal of the group during a period corresponding to N times the maximum occupancy time interval available on the communication medium, N being the least current backoff value from the backoff values of the communication terminals of the group.

37. A communication terminal according to claim 21, wherein the control unit is further configured for outputting a message indicating that the communication medium is reserved by said another communication terminal for said occupancy duration.

38. A communication terminal according to claim 25, wherein the control unit is further configured for determining the timeslot by dividing the sum of the first and second amount of data by the physical data rate.

39. (canceled)

40. (canceled)

41. A method of data communication in a communication network, said network comprising at least one group of communication terminals, wherein, when a communication terminal of the group is about to reserve an occupancy time interval, each of a plurality of communication terminals of said at least one group performs a method according to claim 1 in order to determine a respective timeslot in the time occupancy interval.

42. A method according to claim 1, wherein the determining step comprises performing calculations by the first terminal.

43. A method according to claim 1, wherein the communication medium is accessed according to a Carrier Sense Multiple Access with Collision Avoidance (CSMA/CA) technique.

44. A communication terminal according to claim 19, wherein, in order to determine the timeslot, the control unit is further configured for performing calculations.

45. A communication terminal according to claim 19, wherein communication over the communication medium is performed according to a Carrier Sense Multiple Access with Collision Avoidance (CSMA/CA) technique.

46. A communication system comprising a group of communication terminals according to claim 19, wherein each communication terminal of a plurality of terminals of the system is configured to determine a respective timeslot in an occupancy time interval that is to be reserved by a communication terminal of the system.
